(19) United States
(12) Patent Application Publication
(10) Pub. No.: US 2014/0090634 A1
(43) Pub. Date: Apr. 3, 2014

(54) Reduce impact by barbecue smoke

(71) Applicants: Fan Li, Waterloo (CA); Jin Guo Wang, Kitchenor (CA)

(72) Inventors: Fan Li, Waterloo (CA); Jin Guo Wang, Kitchenor (CA)

(21) Appl. No.: 13/630,348

(22) Filed: Sep. 28, 2012

(51) Int. Cl. A47J 37/07

(52) U.S. Cl. CPC A47J 37/0754
USPC 126/25 R; 126/299 D

(57) ABSTRACT

A barbecue grill device may include a base member to form a base for the barbecue grill device, a burner housing to be positioned on the base member and an airflow diverter to form an airflow between the user of the barbecue grill device and a burner housing. The barbecue grill may include a bidirectional lid.

### PRIORITY

The present invention claims priority under 35 USC section 119 based upon a provisional application with a Ser. No. 61/540,172 which was filed on Sep. 28, 2011.

### FIELD OF THE INVENTION

The present invention relates to a barbecue grill, particularly to a barbecue grill with an airflow diverter or bidirectional opening of lid to divert the airflow.

### BACKGROUND

In the modern time, there are more and more competitions existed in our society. Nowadays, in order to live, strive for life and feed one's family, everyone needs to work, including man and woman. Therefore, the pressure everyone has endured had become more and more severe. In this reason, people may like to have some barbecue to relieve their stress, and dining, entertainment or several gossips might also be favorable as well.

Conventionally, the barbecue grill is a essential equipment for those activity, as well as the coal, tinder, snack, dessert, drink or sauce are definitely required which can make the barbecue perfect. A byproduct of the barbecue grill in a great many occasions is smoke which may result due to the high heat and meat being cooked on the barbecue grill.

The direction of the smoke may vary depending on the wind direction and strength. A great many cases, the smoke is directed towards the cook and/or guests. It would be desirable to be able to control the direction of the smoke in order to provide a more pleasant cooking experience.

### SUMMARY

A barbecue grill device may include a base member to form a base for the barbecue grill device, a lid for a burner housing to be positioned on the base member and an airflow diverter to form an airflow between the user of the barbecue grill device and a burner housing.

The airflow diverter may include an airflow generator to generate a flow of air.

The airflow diverter may include a turbine to generate the flow of air.

The airflow generator may be connected to a connection tube.

The connection tube may be connected to an airflow distributor to distribute the airflow.

The airflow diverter may include an airflow guide to guide the airflow.

The airflow guide may include a vertical nozzle.

The vertical nozzle may include a sloping side.

The lid may open bidirectionally.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the barbecue grill of the present invention without the airflow diverter;

FIG. 2 illustrates a perspective view of the airflow diverter of the present invention;

FIG. 3 illustrates a perspective view of the barbecue grill and airflow diverter of the present invention;

FIG. 4 illustrates a perspective view of the airflow diverter of the present invention;

FIG. 5 illustrates a perspective view of the airflow diverter of the present invention;

FIG. 6 illustrates a perspective view of the airflow diverter of the present invention;

FIG. 7 illustrates a sectional view of an alternative design of a nozzle tip to have a better airflow and reduced waste buildup on top of the nozzle:

FIG. 8 illustrates a sectional view of the airflow diverter of the present invention;

FIG. 9 illustrates a sectional view of the airflow diverter of the present invention;

FIG. 10 illustrates a front view of the barbecue grill of the present invention;

FIG. 11 illustrates a side view of the barbecue grill of the present invention;

FIG. 12 illustrates a sectional view of the airflow diverter of the present invention;

FIG. 13 illustrates a perspective view of an alternate design of the present invention.

### DETAILED DESCRIPTION

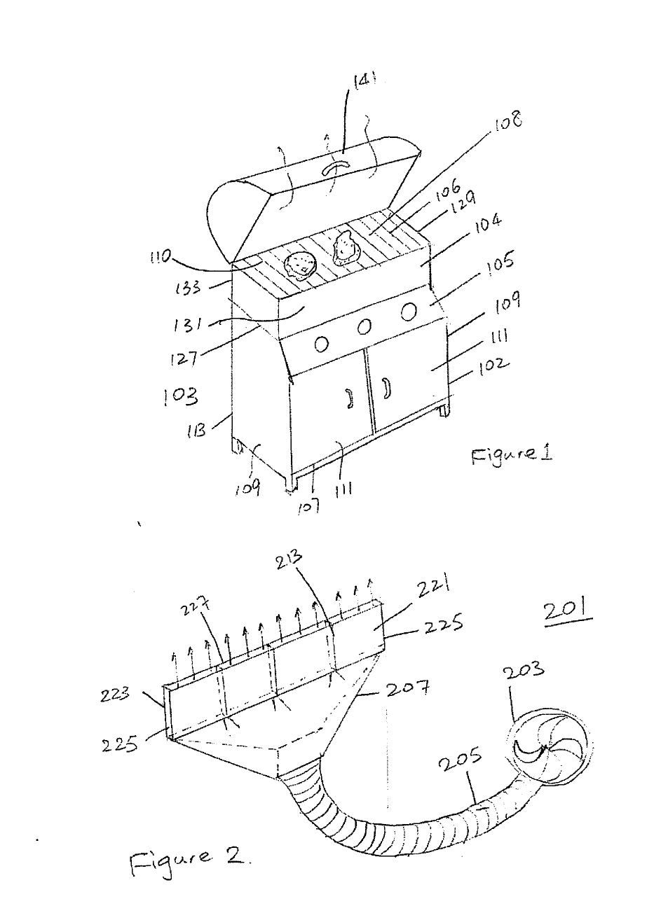

The barbecue grill device 103 as illustrated in FIG. 1 may include a base member 102 which may include a pair of opposing front doors 111 which may be opposed to a back first wall 113 and may be pivotably (for example by hinges) connected to a pair of opposing side first walls 109, the bottom first wall 107 may be connected to the pair of opposing side first walls 109 and the back first wall 113, the back first wall 113 may be connected to the bottom first wall 107, and the side first wall 109, and the pair of side first walls 109 may be connected to its the bottom first wall 107, the pair of opposing front doors 111 more particularly a pivotal connection by hinges or other appropriate devices, a first inclined top wall 105 and the back first wall 103. The first inclined top wall 105 may be connected to the pair of opposing side first wall 109.

The barbecue grill device 103 as shown in FIG. 1 may include a burner housing 104 which may include a front second wall 131 which may be opposed to a back second wall 133 and may be connected to a pair of opposing side second walls 129 and the bottom second wall 127. The bottom second wall 127 may be connected to the pair of opposing side second walls 129, the front second wall 131 and the back second wall 133, the back front wall 133 may be connected to the bottom second wall 127, and the side second wall 129, and the pair of opposing side second walls 129 may be connected to the bottom second wall 127, front second wall 131 and the back second wall 133.

The burner housing 104 may define a cavity 106 by the front second wall 131, the back second wall 133, the side second walls 129 and the bottom second wall 127. The burner housing 104 may house burner units 108 which may be connected to a supply of propane gas or other type of suitable gas. The top of the burner housing 104 may be connected to a wire grill 110 to prevent food from falling into the burner units 108.

The burner housing 104 may be pivotably connected for example by hinges or other connecting devices to a dome shaped lid 141 in order to allow the barbecue grill 103 to be substantially closed.

The present invention provides an air flow diverter 201 which may cooperate with a barbecue grill 103 in order to divert the airflow around the barbecue grill 103 away from the user of the barbecue grill 103. The airflow diverter 201 may include an airflow generator 203 which may be a electric turbine to generate an airflow for the airflow diverter 201, a connection tube 205 to connect the airflow generator 203 to an airflow distributor 207 which may be used to distribute the airflow which had been generated by the airflow generator 203 and an airflow guide 209 to guide the airflow from the airflow distributor 207 to generate an airflow curtain 209.

The airflow distributor 207 may include a cross-section of a cylinder, a truncated triangle, a cone or other appropriate shape and may be hollow.

FIG. 2 illustrates that the airflow distributor 207 may include a longitudinal triangle cross-section which may be truncated and may be connected to the airflow guide 209 (not shown in FIG. 2) which may be a substantial rectangle having a planar front surface 221 which may be opposed to a planar back surface 223 and which may be connected to a planar side surface 225 and the airflow aperture 227. The back surface 223 may be connected to the side surface 225 and the airflow aperture 227 and the side surface 225 may be connected to the back surface 223, the front surface 221 and the airflow aperture 227.

The airflow guide 209 may include vertical nozzles 213 which extend vertically through the airflow guide 209 and may be apertures which may narrow as the apertures approach the airflow aperture 227 in order to increase the speed of the airflow. FIG. 2 illustrates an array of the vertical nozzles 213 which may extend along the airflow guide 209.

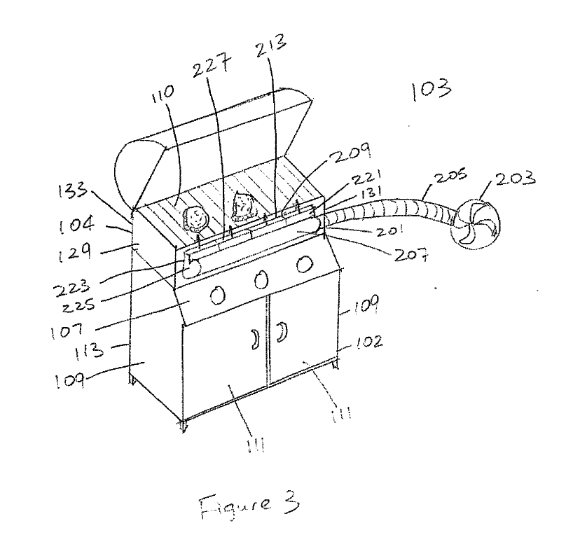

The barbecue grill device 103 as illustrated in FIG. 3 may include a base member 102 which may include a pair of opposing front doors 111 which may be opposed to a back first wall 113 and may be pivotably (for example by hinges) connected to a pair of opposing side first walls 109, the bottom first wall 107 may be connected to the pair of opposing side first walls 109 and the back first wall 113, the back first wall 113 may be connected to the bottom first wall 107, and the side first wall 109, and the pair of side first walls 109 may be connected to its the bottom first wall 107, the pair of opposing front doors 111 more particularly a pivotal connection by hinges or other appropriate devices, a first inclined top wall 105 and the back first wall 103. The first inclined top wall 105 may be connected to the pair of opposing side first wall 109.

The barbecue grill device 103 as shown in FIG. 3 may include a burner housing 104 which may include a front second wall 131 which may be opposed to a back second wall 133 and may be connected to a pair of opposing side second walls 129 and the bottom second wall 127. The bottom second wall 127 may be connected to the pair of opposing side second walls 129, the front second wall 131 and the back second wall 133, the back front wall 133 may be connected to the bottom second wall 127, and the side second wall 129, and the pair of opposing side second walls 129 may be connected to the bottom second wall 127, front second wall 131 and the back second wall 133.

The burner housing 104 may define a cavity 106 by the front second wall 131, the back second wall 133, the side second walls 129 and the bottom second wall 127. The burner housing 104 may house burner units 108 which may be connected to a supply of propane gas or other type of suitable gas. The top of the burner housing 104 may be connected to a wire grill 110 to prevent food from falling into the burner units 108.

The burner housing 104 may be pivotably connected for example by hinges or other connecting devices to a dome shaped lid 141 in order to allow the barbecue grill 103 to be substantially closed.

The present invention provides an air flow diverter 201 which may cooperate with a barbecue grill 103 in order to divert the airflow around the barbecue grill 103 away from the user of the barbecue grill 103. The airflow diverter 201 may include an airflow generator 203 which may be a electric turbine to generate an airflow for the airflow diverter 201, a connection tube 205 to connect the airflow generator 203 to an airflow distributor 207 which may be used to distribute the airflow which had been generated by the airflow generator 203 and an airflow guide 209 to guide the airflow from the airflow distributor 207 to generate an airflow curtain 209.

The airflow distributor 207 may include a cross-section of a cylinder, a truncated triangle, a cone or other appropriate shape and may be hollow.

FIG. 3 illustrates that the airflow distributor 207 may include a longitudinal triangle cross-section which may be truncated and may be connected to the airflow guide 209 which may be a substantial rectangle having a planar front surface 221 which may be opposed to a planar back surface 223 and which may be connected to a planar side surface 225 and the airflow aperture 227. The back surface 223 may be connected to the side surface 225 and the airflow aperture 227 and the side surface 225 may be connected to the back surface 223, the front surface 221 and the airflow aperture 227.

The airflow guide 209 may include vertical nozzles 213 which extend vertically through the airflow guide 209 and may be apertures which may narrow as the apertures approach the airflow aperture 227 in order to increase the speed of the airflow. FIG. 3 illustrates an array of the vertical nozzles 213 which may extend along the airflow guide 209.

FIG. 4 illustrates the airflow diverter 201 of the present invention. The present invention provides an air flow diverter 201 which may cooperate with a barbecue grill 103 in order to divert the airflow around the barbecue grill 103 away from the user of the barbecue grill 103. The airflow diverter 201 may include an airflow generator 203 which may be a electric turbine to generate an airflow for the airflow diverter 201, a connection tube 205 to connect the airflow generator 203 to an airflow distributor 207 which may be used to distribute the airflow which had been generated by the airflow generator 203 and an airflow guide 209 to guide the airflow from the airflow distributor 207 to generate an airflow curtain 209.

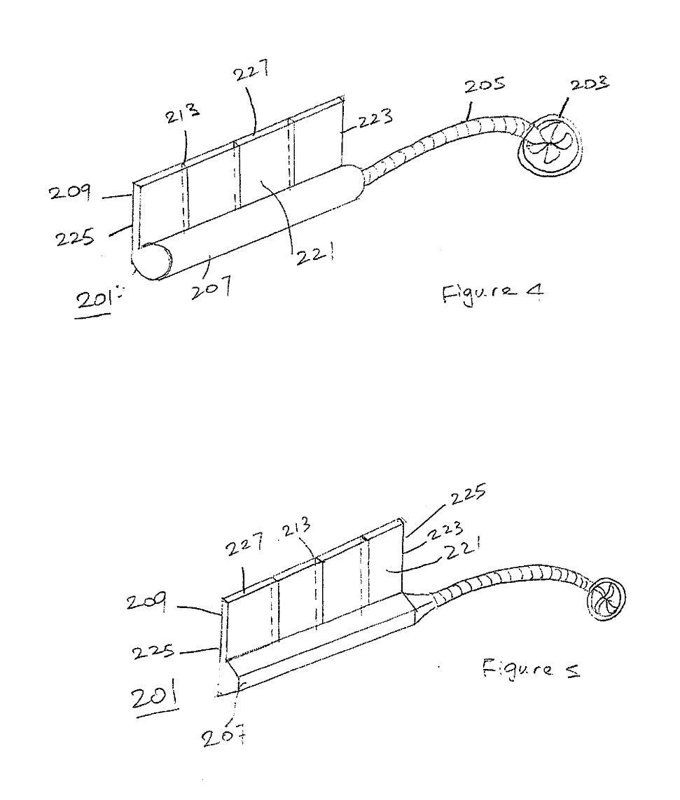

The airflow distributor 207 may include a cross-section of a cylinder as shown in FIG. 4, a truncated triangle as shown in FIG. 5, a cone or other appropriate shape and may be hollow.

FIG. 5 illustrates that the airflow distributor 207 may include a longitudinal triangle cross-section which may be truncated and may be connected to the airflow guide 209 which may be a substantial rectangle having a planar front surface 221 which may be opposed to a planar back surface 223 and which may be connected to a pair of opposing planar side surface 225 and the planar airflow aperture 227. The back surface 223 may be connected to the side surface 225 and the airflow aperture 227 and the side surface 225 may be connected to the back surface 223, the front surface 221 and the airflow aperture 227.

The airflow guide 209 may include vertical nozzles 213 which extend vertically through the airflow guide 209 and may be apertures which may narrow as the apertures approach the airflow aperture 227 in order to increase the speed of the airflow. FIG. 5 illustrates an array of the vertical nozzles 213 which may extend along the airflow guide 209.

FIG. 6 illustrates a perspective view of the airflow distributor 207 and the vertical nozzle 213 which may include inward sloping dividing wall 231 in order to increase the speed of the airflow due to the compression of the airflow.

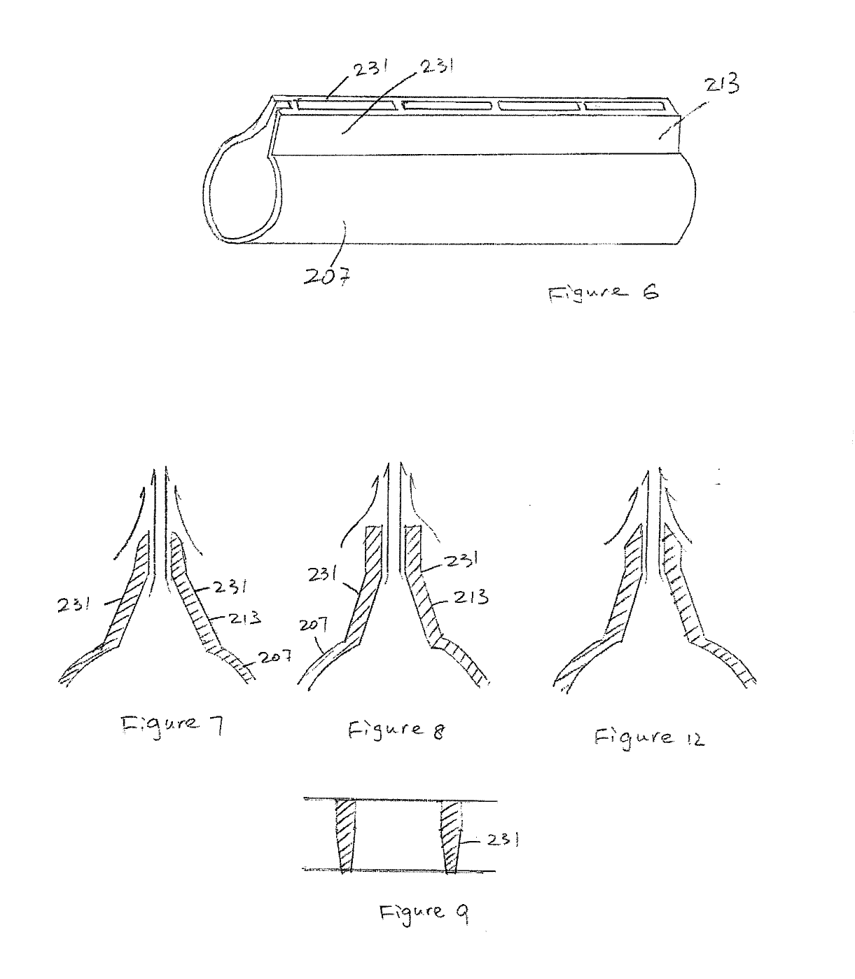

FIG. 7 illustrates a cross-sectional view of a portion of the airflow distributor 207 and the vertical nozzle 213 which may include inward sloping dividing wall 231 in order to increase the speed of the airflow due to the compression of the airflow.

FIG. 8 illustrates a cross-sectional view of another portion of the airflow distributor 207 and the vertical nozzle 213 which may include inward sloping dividing wall 231 in order to increase the speed of the airflow due to the compression of the airflow.

FIG. 12 illustrates a cross-sectional view of another portion of the airflow distributor 207 and the vertical nozzle 213 which may include inward sloping dividing wall 231 in order to increase the speed of the airflow due to the compression of the airflow.

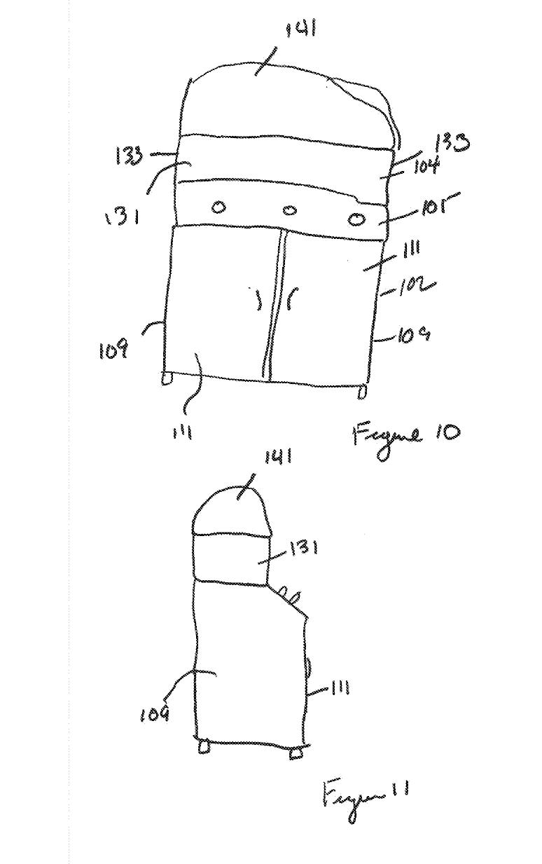

FIG. 9 illustrates a cross-sectional view of a portion of the vertical nozzle 213 and illustrates the inward sloping dividing wall 231.

FIG. 10 illustrates a front view of the barbecue grill device 103 and illustrates the base member 102 and the burner housing 104.

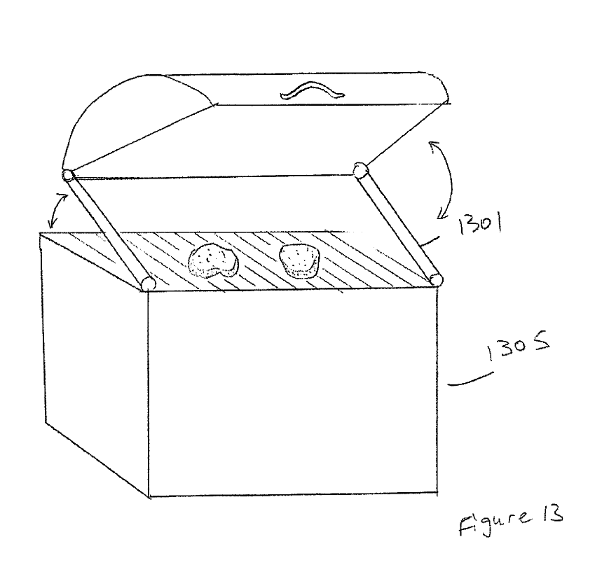

FIG. 11 illustrates a side view of the barbecue grill device 103 and illustrates the base member 102 and the burner housing 104.

FIG. 13 illustrates a perspective view of a barbecue grill device 1305 which may include a lid 1303 which may pivot on arms 1301 to open by bidirectionally which may allow the user to work the grill from both sides to provide an advantage of changing sides to accommodate changing wind direction.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A barbecue grill device, comprising:
a base member to form a base for the barbecue grill device;
a burner housing to be positioned on the base member;
an airflow diverter to form an airflow between the user of the barbecue grill device and a burner housing.

2. A barbecue grill device as in claim 1, wherein the airflow diverter includes an airflow generator to generate a flow of air.

3. A barbecue grill device as in claim 2, wherein the airflow diverter includes a turbine to generate the flow of air.

4. A barbecue grill device as in claim 2, wherein the airflow generator is connected to a connection tube.

5. A barbecue grill device as in claim 4, wherein the connection tube is connected to an airflow distributor to distribute the airflow.

6. A barbecue grill device as in claim 5, wherein the airflow diverter includes an airflow guide to guide the airflow.

7. A barbecue grill device as in claim 6, wherein the airflow guide includes a vertical nozzle.

8. A barbecue grill device as in claim 7, wherein the vertical nozzle includes a sloping side.

9. A barbecue grill device as in claim 1, wherein the lid opens bidirectionally.
